(19) United States
(12) Patent Application Publication
(10) Pub. No.: US 2019/0012186 A1
(43) Pub. Date: Jan. 10, 2019

(54) DETERMINING A STARTUP CONDITION IN A DORMANT STATE OF A MOBILE ELECTRONIC DEVICE TO AFFECT AN INITIAL ACTIVE STATE OF THE DEVICE IN A TRANSITION TO AN ACTIVE STATE

(71) Applicant: LENOVO (Singapore) PTE. LTD., New Tech Park (SG)

(72) Inventors: GRIGORI ZAITSEV, Durham, NC (US); AXEL RAMIREZ FLORES, Cary, NC (US); SCOTT EDWARDS KELSO, Cary, NC (US); JOHN WELDON NICHOLSON, Cary, NC (US)

(21) Appl. No.: 15/644,114

(22) Filed: Jul. 7, 2017

(51) Int. Cl. G06F 9/445; G06F 9/48; G06F 3/01; G06F 3/041

(52) U.S. Cl. CPC G06F 9/44505; G06F 3/0412; G06F 3/017; G06F 9/4881

(57) ABSTRACT

An apparatus for executing a command associated with a startup condition includes a processor and a memory that stores code executable by the processor to determine a startup condition of a mobile electronic device in a dormant state. The startup condition affects an initial active state of the mobile electronic device upon transition from the dormant state to an active state. The code executable by the processor includes code to select a command associated with the startup condition. The startup condition differs from a default startup condition of the mobile electronic device upon a transition from the dormant state to a default active state. The code executable by the processor includes code to execute the command during a transition of the mobile electronic device to an active state.

### BACKGROUND

Mobile electronic devices and other computing devices typically include a login or startup that activates a typical screen with icons, window of applications running previously, etc. The user of the devices may want to change the startup so that other applications may run or other conditions may be set during startup.

### BRIEF SUMMARY

An apparatus for executing a command associated with a startup condition is disclosed. A method and computer program product also perform the functions of the apparatus. The apparatus includes a processor and a memory that stores code executable by the processor to determine a startup condition of a mobile electronic device in a dormant state. The startup condition affects an initial active state of the mobile electronic device upon transition from the dormant state to an active state. The code executable by the processor includes code to select a command associated with the startup condition. The startup condition differs from a default startup condition of the mobile electronic device upon a transition from the dormant state to a default active state. The code executable by the processor includes code to execute the command during a transition of the mobile electronic device to an active state.

A method for executing a command associated with a startup condition includes determining a startup condition of a mobile electronic device in a dormant state. The startup condition affects an initial active state of the mobile electronic device upon transition from the dormant state to an active state. The method includes selecting a command associated with the startup condition, where the startup condition differs from a default startup condition of the mobile electronic device upon a transition from the dormant state to a default active state. The method includes executing the command during a transition of the mobile electronic device to an active state.

A program product for executing a command associated with a startup condition comprises a computer readable storage medium that stores code executable by a processor. The executable code includes code to determine a startup condition of a mobile electronic device in a dormant state. The startup condition affects an initial active state of the mobile electronic device upon transition from the dormant state to an active state. The executable code includes code to select a command associated with the startup condition, where the startup condition differs from a default startup condition of the mobile electronic device upon a transition from the dormant state to a default active state, and to execute the command during a transition of the mobile electronic device to an active state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system with mobile electronic devices;

FIG. 2 is a schematic block diagram illustrating one embodiment of a mobile electronic device with an embodiment of a startup condition module and other components of the mobile electronic device;

FIG. 3 is a schematic block diagram illustrating one embodiment of a startup condition module;

FIG. 4 is a schematic block diagram illustrating another embodiment of a startup condition module;

FIG. 5 is a schematic flow chart diagram illustrating one embodiment of a method for executing a command associated with a startup condition; and

FIG. 6 is a schematic flow chart diagram illustrating another embodiment of a method for executing a command associated with a startup condition.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage media storing machine readable code, computer readable code, and/or program code, referred hereafter as code. The storage devices may be tangible, non-transitory, and/or non-transmission. The storage devices may not embody transitory signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or executable code for execution by various types of processors. An identified module of executable code may, for instance, comprise one or more physical or logical blocks of executable code which may, for instance, be organized as an object, procedure, or function. Nevertheless, the executable code of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, the executable code may include operational data that may be identified and illustrated herein within modules, and may be embodied in any suitable form and organized within any suitable type of data structure. The operational data may be collected as a single data set, or may be distributed over different locations including over different computer readable storage media. Where a module or portions of a module are implemented in executable, the executable portions are stored on one or more computer readable storage media.

Any combination of one or more computer readable media may be utilized. A computer readable medium may be a computer readable storage medium. The computer readable storage medium may be a storage device storing the code. The storage device may be, for example, but not limited to, an electronic storage device, a magnetic storage device, an optical storage device, an electromagnetic storage device, an infrared storage device, a holographic storage device, a micromechanical storage device, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus for executing a command associated with a startup condition is disclosed. A method and computer program product also perform the functions of the apparatus. The apparatus includes a processor and a memory that stores code executable by the processor to determine a startup condition of a mobile electronic device in a dormant state. The startup condition affects an initial active state of the mobile electronic device upon transition from the dormant state to an active state. The code executable by the processor includes code to select a command associated with the startup condition. The startup condition differs from a default startup condition of the mobile electronic device upon a transition from the dormant state to a default active state. The code executable by the processor includes code to execute the command during a transition of the mobile electronic device to an active state.

In one embodiment, determining the startup condition includes receiving a gesture from a user of a mobile electronic device. The gesture is received through a sensor of the mobile electronic device while the mobile electronic device is in a dormant state. In another embodiment, the sensor of the mobile electronic device includes a touchscreen, an accelerometer, a proximity sensor and/or a gyroscope. In another embodiment, the gesture includes touches to the touchscreen and/or swipes across the touchscreen. In another embodiment, the gesture includes one or more movements of the mobile electronic device in a particular pattern.

In another embodiment, executing the command is in response to the mobile electronic device transitioning to an active state, where the mobile electronic device transitions to the active state in response to user input different than the gesture. In another embodiment, executing the command is in response to the mobile electronic device transitioning to an active state, where the mobile electronic device transitions to the active state in response to the gesture. In another embodiment, receiving a gesture includes receiving a plurality of gestures, where each gesture is mapped to a different command. In the embodiment, the code executable by the processor includes code executable by the processor to place the received gestures in a gesture queue in an order that the gestures are received, where executing the command includes executing at least a first command in the gesture queue. In another embodiment, executing the command includes executing each command in the gesture queue in an order dictated by a command execution priority or executing each command in the gesture queue in an order of last received gesture to first received gesture. In another embodiment, receiving a gesture includes receiving a plurality of gestures and executing the command includes executing a command correlated with a last received gesture while ignoring previously received gestures.

In some embodiments, the determined startup condition includes a scheduled state at a time that the mobile electronic device transitions to the active state, where selecting a command associated with the startup condition includes selecting a command associated with the scheduled state. In another embodiment, code executable by the processor to determine the startup condition includes code to receive a gesture from a user of a mobile electronic device and the gesture is received through a sensor of the mobile electronic device while the mobile electronic device is in a dormant state. In the embodiment, selecting a command associated with the startup condition includes selecting a command associated with a combination of the gesture and the scheduled state.

In one embodiment, the determined startup condition includes a state of lighting of surroundings of the mobile electronic device at a time that the mobile electronic device transitions to the active state, where the state of lighting is determined by an amount of light sensed by a light sensor of the mobile electronic device. In the embodiment, selecting a command associated with the startup condition includes selecting a command associated with the state of lighting. In another embodiment, code executable by the processor to determine the startup condition includes code to receive a gesture from a user of a mobile electronic device, where the gesture is received through a sensor of the mobile electronic device while the mobile electronic device is in a dormant state. In the embodiment, selecting a command associated with the startup condition includes selecting a command associated with a combination of the gesture and the state of lighting.

In various embodiments, the command includes sending a message to summons help, executing a camera application to operate a camera of the mobile electronic device, opening an email application, opening a text messaging application, playing a sound on the mobile electronic device, preventing display of personal information, opening a gaming application, opening a note taking application, opening a voice recording application, opening a flashlight application, opening a calculator application, opening a social media application and/or opening a media display application.

A method for executing a command associated with a startup condition includes determining a startup condition of a mobile electronic device in a dormant state. The startup condition affects an initial active state of the mobile electronic device upon transition from the dormant state to an active state. The method includes selecting a command associated with the startup condition, where the startup condition differs from a default startup condition of the mobile electronic device upon a transition from the dormant state to a default active state. The method includes executing the command during a transition of the mobile electronic device to an active state.

In one embodiment, determining the startup condition includes receiving a gesture from a user of a mobile electronic device, where the gesture is received through a sensor of the mobile electronic device while the mobile electronic device is in a dormant state. In another embodiment, the determined startup condition includes a scheduled state at a time that the mobile electronic device transitions to the active state. In the embodiment, selecting a command associated with the startup condition includes selecting a command associated with the scheduled state.

In another embodiment, the determined startup condition includes a state of lighting of surroundings of the mobile electronic device at a time that the mobile electronic device transitions to the active state. The state of lighting is determined by an amount of light sensed by a light sensor of the mobile electronic device. In the embodiment, selecting a command associated with the startup condition includes selecting a command associated with the state of lighting.

A program product for executing a command associated with a startup condition comprises a computer readable storage medium that stores code executable by a processor. The executable code includes code to determine a startup condition of a mobile electronic device in a dormant state. The startup condition affects an initial active state of the mobile electronic device upon transition from the dormant state to an active state. The executable code includes code to select a command associated with the startup condition, where the startup condition differs from a default startup condition of the mobile electronic device upon a transition from the dormant state to a default active state, and to execute the command during a transition of the mobile electronic device to an active state.

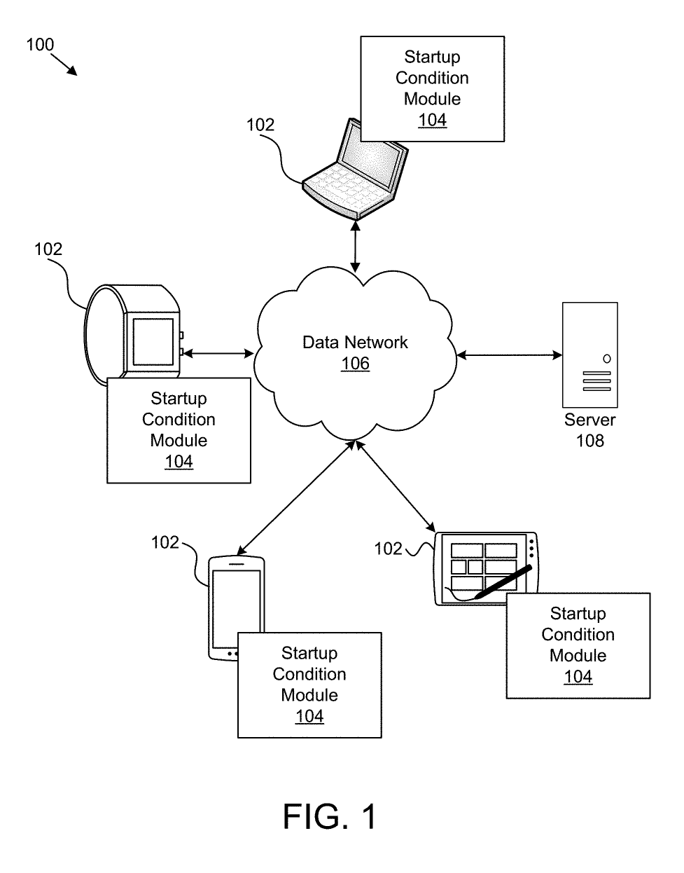

FIG. 1 is a schematic block diagram illustrating one embodiment of a system 100 with mobile electronic devices 102. The system 100 includes mobile electronic devices 102, a startup condition module 104 for each mobile electronic device 102, a data network 106 and a server 108, which are described below.

The system 100 includes one or more mobile electronic devices 102, such as a smart phone, a tablet computer, a smart watch, a fitness band or other wearable activity tracking device, a gaming device, a laptop computer, an optical head-mounted display (e.g., a virtual reality headset, smart glasses, or the like), a High-Definition Multimedia Interface (“HDMI”) or other electronic display dongle, a personal digital assistant, a digital camera, a video camera, and the like. Typically, a mobile electronic device 102 is portable by a user. In other embodiments, the system 100 includes a desktop computer, a server, a workstation, a security system, a set-top box, a gaming console, a smart TV, etc. and may be portable or may have portable components or components that may move, such as a mouse, or may receive input during a dormant state.

Each mobile electronic device 102 is capable of determining a startup condition while the mobile electronic device 102 is in a dormant state, such as sleep mode, standby, or other condition where some of the functionality of the mobile electronic device 102 is inactive. While a mobile electronic device 102 is discussed herein as being portable, other devices may include a startup condition module 104. The startup condition may be gesture input by a user, may be a sensed condition, may be sensed event, and the like.

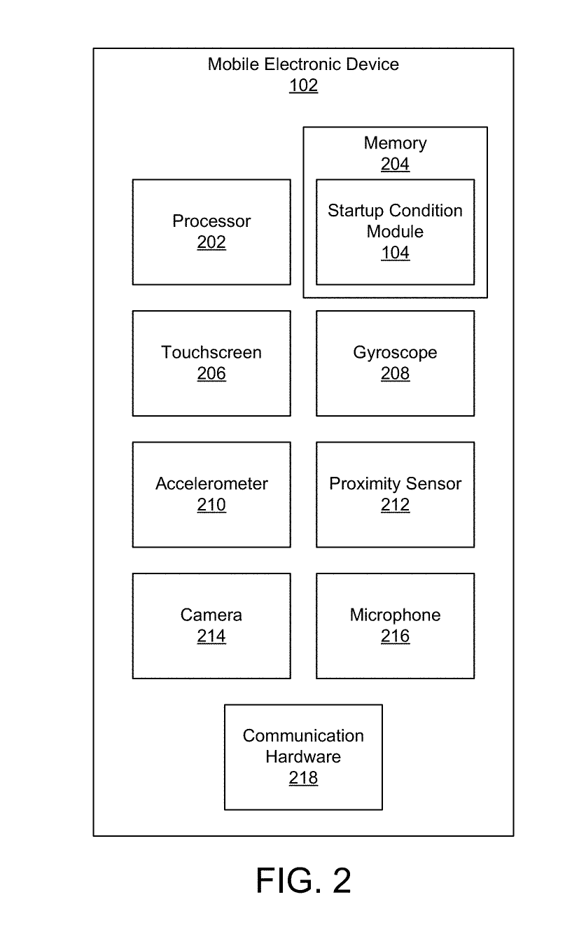

In some embodiments, the startup condition is a gesture input by the user and the mobile electronic device 102 is capable of detecting the gesture using one or more sensors. A mobile electronic device 102, in some embodiments includes one or more sensors that are able to detect a gesture of the user. The sensors will be described further in regards the mobile electronic device 102 of FIG. 2.

The mobile electronic device 102 includes a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the mobile electronic devices 102 are communicatively coupled to one or more other mobile electronic devices 102 and/or to one or more servers 108 over a data network 106, described below. The mobile electronic devices 102, in a further embodiment, may include processors, processor cores, and FPGA, an ASIC and/or the like that are configured to execute various programs, program code, applications, instructions, functions, and/or the like. The mobile electronic devices 102 may include speakers, or other hardware, configured to produce sounds, such as those played during startup, execution of an application, etc.

The startup condition module 104 determines a startup condition of the mobile electronic device 102 that affects an initial active state of the mobile electronic device 102. In the embodiments, startup condition module 104 selects a command associated with the startup condition and executes the command during a transition of the mobile electronic device to an active state. The startup condition differs from a default startup condition of the mobile electronic device 102 upon a transition from the dormant state to a default active state. For example, the command is not a typical login or startup after receiving a password, fingerprint, etc. of the user so that execution of the command brings the mobile electronic device 102 into a state different than a typical startup, log on, etc. The startup condition module 104 solves the technical problem of bringing a mobile electronic device 102 into an initial active state different than a default startup state by determining a startup condition different than a typical login, startup, etc.

In various embodiments, the startup condition module 104 may be embodied as a hardware appliance that can be installed or deployed on a mobile electronic device 102, or elsewhere on the data network 106. In certain embodiments, the startup condition module 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the startup condition module 104 may include a power interface, a wired and/or wireless network interface, a graphical interface that attaches to a display, and/or a semiconductor integrated circuit device as described below, configured to perform the functions described herein with regard to the startup condition module 104.

The startup condition module 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the startup condition module 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the startup condition module 104.

The semiconductor integrated circuit device or other hardware appliance of the startup condition module 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the startup condition module 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM®”), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA®”). Alternatively, the wireless connection may be a cellular telephone network communication. All standards and/or connection types include the latest version and revision of the standard and/or connection type as of the filing date of this application.

FIG. 2 is a schematic block diagram illustrating one embodiment of a mobile electronic device 102 with an embodiment of a startup condition module 104 and other components of the mobile electronic device 102. The mobile electronic device 102 includes a processor 202, memory 204, a touchscreen 206, a gyroscope 208, an accelerometer 210, a proximity sensor 212, a camera 214, a microphone 216 and communication hardware 218, which are described below.

The mobile electronic device 102 includes a processor 202 and memory 204 in communication with the processor 202. The processor 202 may be a central processing unit (“CPU”), a processor core, a field programmable gate array (“FPGA”) or other programmable logic, an application specific integrated circuit (“ASIC”), a controller, a microcontroller, and/or another semiconductor integrated circuit device that may execute commands stored in memory 204. The memory 204 is depicted in FIG. 2 as separate but may be integrated with a processor 202 so that instructions of the startup condition module 104 are integrated in the processor 202. For example, the processor 202 and memory 204 may be implemented in an FPGA, ASIC, etc.

The memory 204 may be implemented as a volatile memory, such as cache, random access memory (“RAM”), etc. and may also include a non-volatile storage medium, such as read-only memory (“ROM”), flash memory, a solid-state drive (“SSD”), or other solid-state storage (“SSS”) a hard disk drive (“HDD”), an optical drive, etc. In one embodiment, the startup condition module 104 is loaded into memory 204 before execution, for example from a hard disk drive to RAM. In another embodiment, the startup condition module 104 is stored in solid-state storage, ROM, etc. that is accessible by the processor 202. One of skill in the art will recognize other ways to implement a processor 202 and memory 204 to store and execute the startup condition module 104.

The mobile electronic device 102, in some embodiments, includes a touchscreen 206 or other electronic display (not shown) in communication with the processor 202 and other devices within the mobile electronic device 102. The touchscreen 206, in one embodiment, may receive a gesture from a user as a startup condition. In the embodiment, the gesture includes the user touching, swiping, etc. the touchscreen 206 while gesturing to input a startup condition. The touchscreen 206 or other electronic display may be integrated into the mobile electronic device 102 or may be separate from the mobile electronic device 102 and is in communication with the mobile electronic device 102 wirelessly or through a cable.

The mobile electronic device 102, in some embodiments, includes a gyroscope 208, an accelerometer 210, a proximity sensor 212 or other motion sensing device that may be used to detect a gesture from the owner. For example, the user may move the mobile electronic device 102 in a particular direction, may shake the mobile electronic device 102, may tilt the mobile electronic device 102, etc. as part of the gesture. The gesture may include a pattern of movements.

The mobile electronic device 102, in some embodiments, includes a camera 214 that may be pointed at the user to receive a gesture from the user. For example, the gesture may include a hand signal, movement of a body part, etc. as a way for the user to input a startup condition as a gesture. In one embodiment, the camera 214 is integrated with the mobile electronic device 102, such as a forward facing camera 214 that is on a same side as a touchscreen 206 of the mobile electronic device 102. In another embodiment, the camera 214 is separate from the mobile electronic device 102 and is connected to the mobile electronic device 102 wirelessly or through a cable. The camera 214 may be controlled and directed by the processor 202 during execution of instructions that are part of the startup condition module 104.

The mobile electronic device 102, in some embodiments, includes a microphone 216, which may receive voice input from the user. The microphone 216 may be integrated with or separate from the mobile electronic device 102. The microphone 216, in one embodiment, may receive input from the user during execution of the startup condition module 104.

The mobile electronic device 102 includes communication hardware 218, such as a network adapter that may communicate with the server 108 or other mobile electronic devices 102. The communication hardware 218 may allow the user to communicate, for example, during a phone call or through digital communications. The communication hardware 218 may include one or more input devices, such as a keyboard, a mouse, etc. The keyboard and/or mouse may be integrated with the mobile electronic device 102, such as keys on the mobile electronic device 102, a touchpad, a keyboard on the touchscreen 206, etc. or may be separate from the mobile electronic device 102.

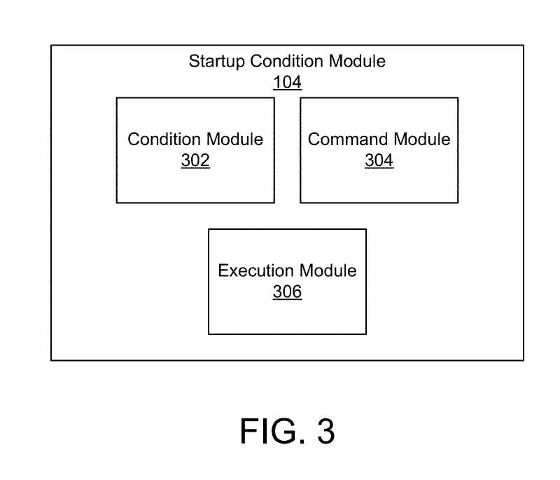

FIG. 3 is a schematic block diagram illustrating one embodiment of a startup condition module 104. The startup condition module 104 includes a condition module 302, a command module 304 and an execution module 306, which are described below.

The startup condition module 104 includes a condition module 302 that determines a startup condition of a mobile electronic device 102 in a dormant state. The dormant state of the mobile electronic device 102, in one embodiment, includes a sleep mode, a standby condition, etc. where the mobile electronic device 102 has devices and applications disabled. Typically, the mobile electronic device 102 in the dormant state is brought to an active state by the user pressing a button, swiping an icon, inputting a password on a login screen, inputting a fingerprint, using a retina scan or other typical login process. Typically, the mobile electronic device 102 will enter the active state from the dormant state by displaying a standard screen, for example with icons on the touchscreen 206 and/or by displaying windows, apps, etc. that were active when the mobile electronic device 102 entered the dormant state.

The user may wish to have the mobile electronic device 102 enter the active state with a particular startup condition. The startup condition affects an initial active state of the mobile electronic device upon transition from the dormant state to the active state. For example, the startup condition may include receiving a gesture from the user and may include opening of a particular application associated with the gesture. In another example, where transitioning to the active state in a dark space, the startup condition may include an active state with a flashlight application opened, with certain icons not shown or dimmed, etc. In another example, the startup condition may include detecting that the user is in a meeting and the startup condition may hide sensitive information, such as personal texts, emails, photographs, etc. In another embodiment, the startup condition may involve determining that the user is on vacation so that the startup condition brings the mobile electronic device 102 to an active state with the camera 214 on or a camera icon in a prominent position on the touchscreen 206.

The startup condition module 104 includes a command module 304 that selects a command associated with the startup condition. The startup condition differs from a default startup condition of the mobile electronic device 102 upon a transition from the dormant state to a default active state. The command module 304 may correlate the startup condition with one or more commands stored in a table. In one embodiment, the startup condition relates to a single command. In another embodiment, the startup condition correlates to two or more commands. Each command affects transitioning of the mobile electronic device 102 to the active state so that the active state is not the typical default active state that typically occurs during a typical user login, button press to activate the mobile electronic device 102, etc.

The startup condition module 104 includes an execution module 306 that executes the command during a transition of the mobile electronic device 102 to an active state. In one embodiment, the execution module 306 executes the command during a startup command by the user. For example, the condition module 302 may determine a startup condition in the dormant state and then the mobile electronic device 102 may receive user credentials, such as a password, personal identification number (“PIN”), fingerprint, etc. or may receive a button press or swipe associated with bringing the mobile electronic device 102 to the active state. The execution module 306 may then execute the command as part of the login or startup process. In another embodiment, execution of the command by the execution module 306 brings the mobile electronic device 102 to the active state.

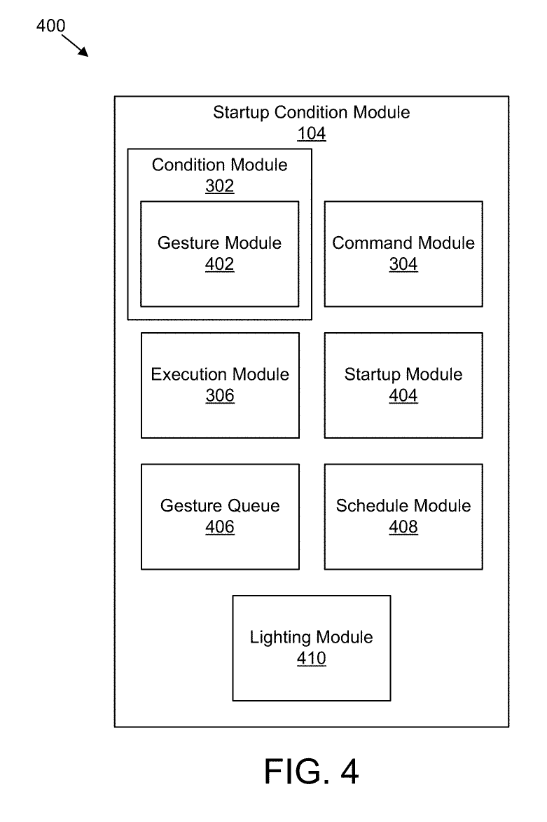

FIG. 4 is a schematic block diagram illustrating another embodiment of a startup condition module 104. In the embodiment, the startup condition module 104 includes a condition module 302, a command module 304 and an execution module 306 which are substantially similar to those described above in relation to the startup condition module 104 of FIG. 2. The startup condition module 104 of FIG. 3 also includes, in some embodiments, a gesture module 402 in the condition module 302, a startup module 404, a gesture queue 406, a schedule module 408 and a lighting module 410, which are described below.

In some embodiments, the condition module 302 includes a gesture module 402 and the condition module 302 determining the startup condition includes the gesture module 402 receiving a gesture from a user of a mobile electronic device 102. The gesture is received through a sensor of the mobile electronic device 102 while the mobile electronic device 102 is in a dormant state. In the embodiment, the gesture is all or part of the startup condition.

In one embodiment, the sensor of the mobile electronic device 102 includes a touchscreen 206 and the gesture module 402 receives the gesture by sensing touches and/or swipes across the touchscreen 206 in a particular pattern. For example, the user may tap and or swipe the touchscreen 206 in a particular pattern to input a particular gesture and the gesture module 402 may detect the gesture and the command module 304 may then select a command that is associated with the gesture. In the embodiment, the gesture excludes tapping, swiping or otherwise selecting icons or similar items displayed on the touchscreen 206. For example, the gesture does not include tapping an icon associated with startup or launching an application or swiping a control bar the activates an application, command, etc. on the mobile electronic device 102. The gesture, in one embodiment, is performed in regions of the touchscreen 206 without displayed icons, controls, etc.

In another embodiment, the sensor of the mobile electronic device 102 includes an accelerometer 210, a proximity sensor 212 a gyroscope 208, etc. and the gesture module 402 receives the gesture by sensing one or more movements of the mobile electronic device 102 in a particular pattern. The movements may include tilting, shaking, rotating, etc. the mobile electronic device 102 in a particular pattern where each pattern corresponds to one or more commands. For example, tilting the mobile electronic device 102 to the right three times and once to the left may correlate to a command that brings up an email operation.

In another embodiment, the sensor of the mobile electronic device 102 includes the camera 214 and the gesture module 402 receives the gesture by detecting a finger, a hand, etc. of the user moving in a particular pattern. In the embodiment, a particular action of the user may activate the camera 214 during the dormant state.

In one embodiment, the startup condition module 104 includes a startup module 404 and the execution module 306 executes the command is in response to the startup module 404 receiving a startup command and mobile electronic device 102 transitioning to an active state based on the startup command. The mobile electronic device 102 transitions to the active state in response to the startup module 404 receiving user input different than the gesture, such as a typical login or startup command. In another embodiment, the mobile electronic device 102 transitions to the active state in response to the gesture without action by the startup module 404.

In one embodiment, the gesture module 402 receives more than one gesture each mapped to a different command and the gesture module 402 stores the gestures in a gesture queue 406. In another embodiment, the command module 304 stores commands associated with the multiple gestures in the gesture queue 406. The gesture module 402 may store the commands in an order received. The command module 304 may then select a command corresponding to each gesture. The execution module 306 may execute the commands in various ways.

For example, the execution module 306 may execute at least the first command in the gesture queue 406. In another example, the execution module 306 executes multiple commands based on the gestures in the gesture queue 406. For example, where each command corresponds to an application, the execution module 306 starts the applications corresponding to the gestures upon transition of the mobile electronic device 102 to the active state.

In one embodiment, the execution module 306 executes each command in the gesture queue in an order dictated by a command execution priority. In another embodiment, the execution module 306 executes each command in the gesture queue in an order of last received gesture to first received gesture. In another embodiment, the execution module 306 executes a command correlated with a last received gesture while ignoring previously received gestures. One of skill in the art will recognize other ways to execute commands based on gestures in a gesture queue 406.

The startup condition module 104, in some embodiments, includes a schedule module 408 that allows a user to schedule events that affect startup conditions. In one embodiment, the startup condition determined by the condition module 302 includes a scheduled state at a time that the mobile electronic device 102 transitions to the active state. The command module 304 selects a command associated with the startup condition associated with the scheduled state. For example, the user may schedule a meeting or may set a flag while setting up a meeting so that when the user uses the startup module 404 to transition the mobile electronic device 102 to an active state during the meeting, the command module 304 executes a command associated with the scheduled state. For example, the command may hide sensitive information or applications, may turn off volume on the mobile electronic device 102, may bring up a note taking application, and the like. The scheduled state may include a meeting, a meeting at a particular location, a scheduled event, such as a movie, sleeping, a meal at a restaurant, etc.

In one embodiment, the condition module 302 determining the startup condition includes the gesture module 402 receiving a gesture from a user of a mobile electronic device 102 where the gesture is received through a sensor of the mobile electronic device 102 while the mobile electronic device is in a dormant state during a meeting or other scheduled state. The command module 304 selects a command associated with a combination of the gesture and the scheduled state. For example, if the scheduled state includes hours for sleeping, the command module 304 may select an application and the execution module 306 may execute the command upon transitioning to the active state where the application is silenced or has a low volume setting. In one embodiment, sensors such as a location sensor may also be used to determine the scheduled event along with monitoring of a clock.

In some embodiments, the startup condition module 104 includes a lighting module 410 that senses lighting around the mobile electronic device 102. In one embodiment, the determined startup condition includes a state of lighting of surroundings of the mobile electronic device 102 at a time that the mobile electronic device 102 transitions to the active state. The lighting module 410 determines a state of lighting by an amount of light sensed by a light sensor of the mobile electronic device 102. The command module 304, in some embodiments, determines a command based on the state of lighting. For example, the lighting module 410 may detect darkness so that the command module 304 selects a command associated with darkness, such as a flashlight application. In another example, the lighting module 410 detects darkness and a proximity sensor 212 senses that the mobile electronic device 102 is in a pocket of the user or other confined space. The command module 304 may determine an appropriate command based on the startup condition being in a pocket or confined space.

In one embodiment, the gesture module 402 receives a gesture while the lighting module 410 detects a low light condition so the condition module 304 selects a command based on both the low lighting condition and the determined gesture. For example, the mobile electronic device 102 may be placed in a pocket of the user so that the lighting module 410 and/or proximity sensor 212 determine that the mobile electronic device 102 is in the user's pocket. In the example, the user may then use the touchscreen 206 to enter a gesture and the command module 304 may associate the gesture with an emergency call, text or email to summons help.

In other embodiments, gestures and/or other startup conditions may be associated with commands that execute a camera application to operate a camera 214 of the mobile electronic device 102, opening an email application, opening a text messaging application, playing a sound on the mobile electronic device, preventing display of personal information, opening a gaming application, opening a note taking application, opening a voice recording application, opening a flashlight application, opening a calculator application, opening a social media application, and/or opening a media display application, such as a picture viewer, video player, etc. One of skill in the art will recognize other gestures, startup conditions and commands that may be associated with the gestures and/or startup conditions.

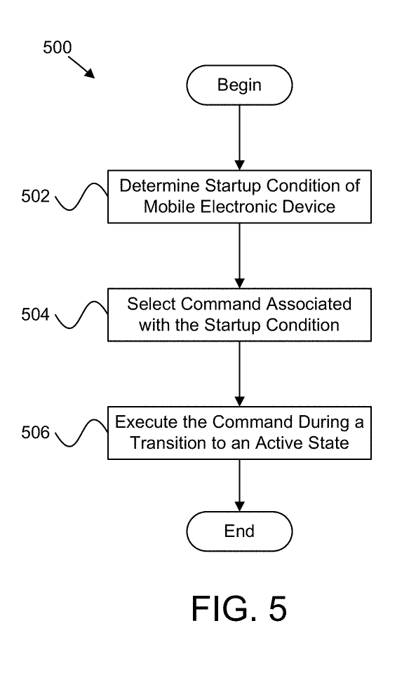

FIG. 5 is a schematic flow chart diagram illustrating one embodiment of a method 500 for executing a command associated with a startup condition. The method 500 begins and determines 502 a startup condition of a mobile electronic device 102 in a dormant state. The startup condition affects an initial active state of the mobile electronic device 102 upon transition from the dormant state to an active state. The method 500 selects 504 a command associated with the startup condition, where the startup condition differs from a default startup condition of the mobile electronic device 102 upon a transition from the dormant state to a default active state. The method 500 executes 506 the command during a transition of the mobile electronic device 102 to an active state, and the method 500 ends. In various embodiments, the condition module 302, the command module 304 and the execution module 306 along with other sensors and components of the mobile electronic device 102 to perform the steps of the method 500.

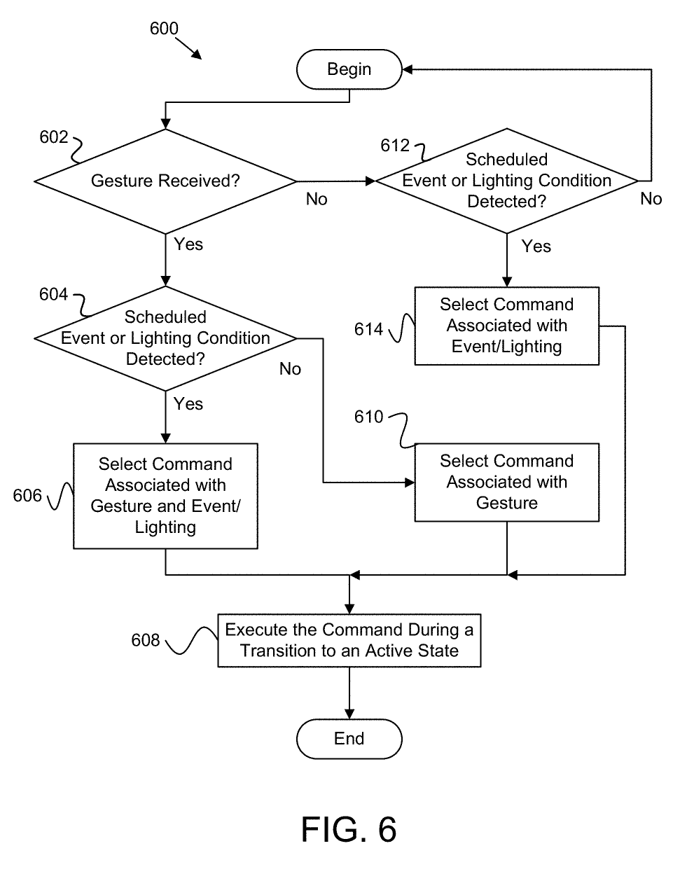

FIG. 6 is a schematic flow chart diagram illustrating another embodiment of a method 600 for executing a command associated with a startup condition. The method 600 begins and determines 602 if a gesture has been received. If the method 600 determines 602 that a gesture has been received, the method 600 determines 604 if a scheduled event or particular lighting condition has been detected. If the method 600 determines 604 that a scheduled event or particular lighting condition has been detected, the method 600 selects 606 a command associated with the gesture and the detected meeting and/or lighting condition and executes 608 the command during a transition to an active state, and the method 600 ends.

If the method 600 determines 604 that a scheduled event or particular lighting condition has not been detected, the method 600 selects 610 a command associated with the gesture and executes 608 the command during a transition to an active state, and the method 600 ends. If the method 600 determines 602 that a gesture has not been received, the method 600 determines 612 if a scheduled event or particular lighting condition has been detected. If the method 600 determines 612 that a scheduled event or particular lighting condition has not been detected, the method 600 returns to the beginning and determines 602 if a gesture has been received.

If the method 600 determines 612 that a scheduled event or particular lighting condition has been detected, the method 600 selects 614 a command associated with the event and/or lighting condition and executes 608 the command during a transition of the mobile electronic device 102 to an active state, and the method 600 ends. In various embodiments, the condition module 302, the command module 304, the execution module 306, the gesture module 402, the startup module 404, the gesture queue 406, the schedule module 408 and the lighting module 410 along with other sensors and components of the mobile electronic device 102 to perform the steps of the method 600.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
determine a selected startup condition of a plurality of startup conditions of a mobile electronic device in a dormant state, the startup condition affecting an initial active state of the mobile electronic device upon transition from the dormant state to an active state, wherein to determine the selected startup condition comprises the processor to receive a gesture from a user of a mobile electronic device, the gesture received through a sensor of the mobile electronic device while the mobile electronic device is in a dormant state, wherein the gesture is correlated to the startup condition;
select a command associated with activating the startup condition, wherein the startup condition differs from a default startup condition of the mobile electronic device upon a transition from the dormant state to a default active state;
receive user login information different from the gesture, wherein the user login information directs the mobile electronic device to transition to the active state; and
execute the command during a transition of the mobile electronic device to the active state to activate the startup condition, wherein executing the command is in response to the mobile electronic device transitioning to the active state and wherein executing the command during the transition to the active state brings the mobile electronic device to the selected startup condition.

2. (canceled)

3. The apparatus of claim 1, wherein the sensor of the mobile electronic device comprises one or more of a touchscreen, an accelerometer, a proximity sensor and a gyroscope.

4. The apparatus of claim 3, wherein the gesture comprises one or more of:
touches to the touchscreen; and
swipes across the touchscreen.

5. The apparatus of claim 3, wherein the gesture comprises one or more movements of the mobile electronic device in a particular pattern.

6. (canceled)

7. (canceled)

8. The apparatus of claim 1, wherein to receive a gesture comprises the processor to receive a plurality of gestures, each gesture mapped to a different command, and further comprising code executable by the processor to place the received gestures in a gesture queue in an order that the gestures are received, wherein to execute the command comprises the processor to execute at least a first command in the gesture queue.

9. The apparatus of claim 8, wherein to execute the command comprises the processor to one or more of:
execute each command in the gesture queue in an order dictated by a command execution priority; and
execute each command in the gesture queue in an order of last received gesture to first received gesture.

10. The apparatus of claim 1, wherein to receive a gesture comprises the processor to receive a plurality of gestures and to execute the command comprises the processor to execute a command correlated with a last received gesture while ignoring previously received gestures.

11. The apparatus of claim 1, wherein the determined startup condition comprises a scheduled state at a time that the mobile electronic device transitions to the active state, wherein to select a command associated with the startup condition comprises the processor to select a command associated with the scheduled state.

12. The apparatus of claim 11, wherein code executable by the processor to determine the startup condition further comprises the processor to receive a gesture from a user of a mobile electronic device, the gesture received through a sensor of the mobile electronic device while the mobile electronic device is in a dormant state and, wherein to select a command associated with the startup condition comprises the processor to select a command associated with a combination of the gesture and the scheduled state.

13. The apparatus of claim 1, wherein the determined startup condition comprises a state of lighting of surroundings of the mobile electronic device at a time that the mobile electronic device transitions to the active state, the state of lighting determined by an amount of light sensed by a light sensor of the mobile electronic device, wherein to select a command associated with the startup condition comprises the processor to select a command associated with the state of lighting.

14. The apparatus of claim 13, wherein code executable by the processor to determine the startup condition further comprises code executable by the processor to receive a gesture from a user of a mobile electronic device, the gesture received through a sensor of the mobile electronic device while the mobile electronic device is in a dormant state and, wherein to select a command associated with the startup condition comprises the processor to select a command associated with a combination of the gesture and the state of lighting.

15. The apparatus of claim 1, wherein the command comprises one or more of:
sending a message to summons help;
executing a camera application to operate a camera of the mobile electronic device;
opening an email application;
opening a text messaging application;
playing a sound on the mobile electronic device;
preventing display of personal information;
opening a gaming application;
opening a note taking application;
opening a voice recording application;
opening a flashlight application;
opening a calculator application;
opening a social media application; and
opening a media display application.

16. A method comprising:
determining a selected startup condition of a plurality of startup conditions of a mobile electronic device in a dormant state, the startup condition affecting an initial active state of the mobile electronic device upon transition from the dormant state to an active state, wherein determining the selected startup condition comprises receiving a gesture from a user of a mobile electronic device, the gesture received through a sensor of the mobile electronic device while the mobile electronic device is in a dormant state, wherein the gesture is correlated to the startup condition;
selecting a command associated with activating the startup condition, wherein the startup condition differs from a default startup condition of the mobile electronic device upon a transition from the dormant state to a default active state;
receiving user login information different from the gesture, wherein the user login information directs the mobile electronic device to transition to the active state; and
executing the command during a transition of the mobile electronic device to the active state to activate the startup condition, wherein executing the command is in response to the mobile electronic device transitioning to the active state and wherein executing the command during the transition to the active state brings the mobile electronic device to the selected startup condition.

17. (canceled)

18. The method of claim 16, wherein the determined startup condition comprises a scheduled state at a time that the mobile electronic device transitions to the active state, wherein selecting a command associated with the startup condition comprises selecting a command associated with the scheduled state.

19. The method of claim 16, wherein the determined startup condition comprises a state of lighting of surroundings of the mobile electronic device at a time that the mobile electronic device transitions to the active state, the state of lighting determined by an amount of light sensed by a light sensor of the mobile electronic device, wherein selecting a command associated with the startup condition comprises selecting a command associated with the state of lighting.

20. A program product comprising a computer readable storage medium that stores code executable by a processor, the executable code comprising code to:
determine a selected startup condition of a plurality of startup conditions of a mobile electronic device in a dormant state, the startup condition affecting an initial active state of the mobile electronic device upon transition from the dormant state to an active state, wherein to determine the selected startup condition comprises the processor to receive a gesture from a user of a mobile electronic device, the gesture received through a sensor of the mobile electronic device while the mobile electronic device is in a dormant state, wherein the gesture is correlated to the startup condition;
select a command associated with activating the startup condition, wherein the startup condition differs from a default startup condition of the mobile electronic device upon a transition from the dormant state to a default active state;
receiving user login information different from the gesture, wherein the user login information directs the mobile electronic device to transition to the active state; and
execute the command during a transition of the mobile electronic device to the active state to activate the startup condition, wherein executing the command is in response to the mobile electronic device transitioning to the active state and wherein executing the command during the transition to the active state brings the mobile electronic device to the selected startup condition.

21. The apparatus of claim 1, wherein the mobile electronic device is in the active state when the functionality of the mobile electronic device is active.

22. The method of claim 16, wherein the mobile electronic device is in the active state when the functionality of the mobile electronic device is active.
